(19) United States
(12) Patent Application Publication
(10) Pub. No.: US 2025/0149585 A1
(43) Pub. Date: May 8, 2025

(54) BINDER FOR SECONDARY BATTERY AND METHOD OF PREPARING THE SAME

(71) Applicants: Hyundai Motor Company, Seoul (KR); Kia Corporation, Seoul (KR); POSTECH Research and Business Development Foundation, Pohang-si (KR)

(72) Inventors: Yong Ho Lee, Incheon (KR); Yoon Sung Lee, Suwon-si (KR); Sung Ho Ban, Hwaseong-si (KR); Hui Beom Nam, Suwon-si (KR); Jun Ki Rhee, Seoul (KR); Tae Rim Lee, Hwaseong-si (KR); Jieun Kang, Pohang-si (KR); Sungho Kim, Pohang-si (KR); Dongjoo Kim, Pohang-si (KR); Soojin Park, Pohang-si (KR)

(21) Appl. No.: 18/657,173

(22) Filed: May 7, 2024

(30) Foreign Application Priority Data
Nov. 6, 2023 (KR) 10-2023-0152114

(51) Int. Cl. H01M 4/62; H01M 4/02; H01M 10/052

(52) U.S. Cl. CPC H01M 4/621; H01M 2004/027; H01M 10/052

(57) ABSTRACT

According to embodiments, a binder for a lithium secondary battery comprises a mixture of dextran and gallic acid obtained through physical stirring. As an example, the binder can be prepared by dissolving dextran in a solvent to form a dextran solution, adding gallic acid to the dextran solution, and, after the adding of the gallic acid to the dextran solution, physically mixing the dextran solution including the added gallic acid to form a mixture.

### CROSS-REFERENCE TO RELATED APPLICATIONS

This application claims priority from Korean Patent Application No. 10-2023-0152114, filed on Nov. 6, 2023, in the Korean Intellectual Property Office, the disclosure of which is incorporated herein by reference in its entirety.

### TECHNICAL FIELD

The present disclosure relates to a lithium secondary battery binder.

### BACKGROUND

Lithium secondary batteries are widely used in portable energy storage devices, electric vehicles and the like due to high energy density, low cost, long cycle life, and safety thereof. The development of lithium-ion batteries with high energy density and long lifespan is attracting a great deal of attention. Although graphite is one of the most commonly used anode materials, low theoretical capacity is a factor limiting the performance of lithium-ion batteries. Silicon, which has a relatively low lithium ion intercalation potential and high theoretical capacity (4,200 mAh/g), is considered an anode for next-generation lithium ion batteries.

However, a silicon anode has not been commercialized due to the enormous volume change occurring during the charging and discharging of the battery. The volume change that occurs during the charging and discharging process causes cracks in the electrode material, ultimately leading to the collapse of the electrically conductive network formed between silicon particles and conductive carbon and a metal-based current collector. Such deterioration of the electrode eliminates electrical contact between the silicon particles and the current collector, resulting in rapid capacity loss. Various research is being conducted to reduce volume changes in silicon.

The information disclosed in this Background section is provided only for enhancement of understanding of the background of the present disclosure, and therefore it may not include information that forms the prior art that is already publicly known, publicly available, or in use publicly.

### SUMMARY

The present disclosure relates to a lithium secondary battery binder containing a mixture of dextran and gallic acid, and a method of preparing the same.

Some embodiments of the present disclosure has been made in view of the above problems, and some embodiments of the present disclosure provide a binder for lithium secondary batteries that contains a mixture of dextran and gallic acid chemically bonded through hydrogen bonding and exhibits excellent adhesion to a silicon-based anode active material, thus effectively reducing large volume changes of silicon-based anode active materials during charging and discharging, and improving the mechanical stability, rate characteristics, and charge/discharge cycling stability of the anode, thereby improving the charge/discharge performance and life characteristics of batteries using the same.

Some embodiments of the present disclosure provide a method of preparing a highly reproducible and efficient binder for lithium secondary batteries containing a mixture of dextran and gallic acid.

Some embodiments are not necessarily limited to those advantages mentioned above and other advantages can be clearly understood by those skilled in the art from the following description.

In accordance with an embodiment of the present disclosure, the above and other advantages can be accomplished by the provision of a binder for lithium secondary batteries containing a mixture of dextran and gallic acid obtained through physical stirring.

For example, the dextran and the gallic acid can form a chemical bond through physical stirring.

For example, the chemical bond between the dextran and the gallic acid may include a hydrogen bond.

For example, the chemical bond between the dextran and the gallic acid may include a covalent bond through polymerization.

For example, a weight of gallic acid may be 4 to 6 wt %, based on 100 wt % of a total weight of a mixture of dextran and gallic acid.

For example, the binder may be prepared by adding gallic acid to a dextran solution, followed by physically stirring.

For example, the mixture of dextran and gallic acid may form a multidimensional contact with an anode active material.

In accordance with an embodiment of the present disclosure, there is provided a method of preparing a binder for a lithium secondary battery including dissolving dextran in a solvent, adding gallic acid to the dextran solution, and followed by physically mixing.

For example, the solvent may be a polar solvent including water.

For example, the dextran and gallic acid during physically mixing may be mixed such that a weight of gallic acid is 4 to 6 wt % based on the total weight of 100 wt % of a mixture of dextran and gallic acid.

For example, the physically mixing may be performed by stirring after adding gallic acid to the dextran solution.

For example, a temperature of the dextran solution during the physically mixing may be 30 to 50° C.

For example, a time of stirring during the mixing may be 11 to 13 hours.

For example, the method may further include casting the mixture onto an electrode and drying the electrode after the mixing.

In accordance with an embodiment of the present disclosure, there is provided an anode for a lithium secondary battery containing a binder containing a mixture of dextran and gallic acid obtained through physical stirring.

For example, the anode may have an adhesive strength, measured by 180° peel-off test, of 20 gf/mm or more.

In accordance with an embodiment of the present disclosure, there is provided a lithium secondary battery containing a binder containing a mixture of dextran and gallic acid obtained through physical stirring.

For example, the lithium secondary battery may have a resistance of 3002 or less after 50 repeated charge/discharge cycles.

### BRIEF DESCRIPTION OF THE DRAWINGS

The above and other features and advantages of the present disclosure can be more clearly understood from the following detailed description taken in conjunction with the accompanying drawings, in which:

FIG. 1 is a diagram that illustrates a binder for lithium secondary batteries according to an embodiment of the present disclosure;

FIG. 2 is a diagram that illustrates a mixture of dextran and gallic acid contained in the lithium secondary battery according to an embodiment of the present disclosure;

FIG. 3 is a flowchart that illustrates an example of a method of preparing a binder for lithium secondary batteries according to an embodiment of the present disclosure;

FIG. 4 is a graph showing the result of adhesive strength test (180° peel-off test) of the electrode in Example 7 according to an embodiment of the present disclosure;

FIG. 5 is a graph showing the result of adhesive strength test (180° peel-off test) of the electrode in Example 8 according to an embodiment of the present disclosure;

FIG. 6 is a graph showing the result of adhesive strength test (180° peel-off test) of the electrode in Example 9 according to an embodiment of the present disclosure;

FIG. 7 is a graph showing the result of adhesive strength test (180° peel-off test) of the electrodes in Comparative Examples 11 to 14 according to an embodiment of the present disclosure;

FIG. 8 is a graph showing the result of adhesive strength test (180° peel-off test) of the electrodes in Comparative Examples 15 and 16 according to an embodiment of the present disclosure;

FIG. 9 is a graph showing the result of electrochemical lifespan test in Example 10 according to an embodiment of the present disclosure;

FIG. 10 is a graph showing the result of electrochemical lifespan test in Example 11 according to an embodiment of the present disclosure;

FIG. 11 is a graph showing the result of electrochemical lifespan test in Example 12 according to an embodiment of the present disclosure;

FIG. 12 is a graph showing the result of electrochemical lifespan test in Comparative Example 17 according to an embodiment of the present disclosure;

FIG. 13 is a graph showing the result of electrochemical lifespan test in Comparative Example 18 according to an embodiment of the present disclosure;

FIG. 14 is a graph showing the result of electrochemical lifespan test in Comparative Example 19 according to an embodiment of the present disclosure;

FIG. 15 is a graph showing the result of electrochemical lifespan test in Comparative Example 20 according to an embodiment of the present disclosure;

FIG. 16 is a graph showing the result of electrochemical lifespan test in Comparative Example 21 according to an embodiment of the present disclosure;

FIG. 17 is a graph showing the result of electrochemical lifespan test in Comparative Example 22 according to an embodiment of the present disclosure;

FIG. 18 is a graph showing the result of electrochemical impedance performance test in Example 13 according to an embodiment of the present disclosure;

FIG. 19 is a graph showing the result of electrochemical impedance performance test in Example 14 according to an embodiment of the present disclosure;

FIG. 20 is a graph showing the result of electrochemical impedance performance test in Example 15 according to an embodiment of the present disclosure;

FIG. 21 is a graph showing the result of electrochemical impedance performance test in Comparative Example 23 according to an embodiment of the present disclosure;

FIG. 22 is a graph showing the result of electrochemical impedance performance test in Comparative Example 24 according to an embodiment of the present disclosure;

FIG. 23 is a graph showing the result of electrochemical impedance performance test in Comparative Example 25 according to an embodiment of the present disclosure; and

FIG. 24 is a graph showing the result of electrochemical impedance performance test in Comparative Example 26 according to an embodiment of the present disclosure.

### DETAILED DESCRIPTION OF ILLUSTRATIVE EMBODIMENTS

Reference will now be made in detail to some embodiments of the present disclosure, examples of which are illustrated in the accompanying drawings. However, the present disclosure is not necessarily limited to the embodiments herein and can be embodied in different forms. Those skilled in the art can appreciate that various modifications, additions, and substitutions can be possible, without departing from the scope and spirit of the present disclosure according to the accompanying claims.

It can be understood that the terms may be used herein can be only to illustrate specific embodiments and should not be construed as necessarily limiting the scope of the present disclosure. Singular forms can include plural forms as well, unless the context clearly indicates otherwise. It can be further understood that the terms “comprises”, “has” and the like, when used in this specification, specify the presence of stated features, numbers, steps, operations, elements, components, or combinations thereof, but do not preclude the presence or addition of one or more other features, numbers, steps, operations, elements, components, or combinations thereof.

It can be understood that, in the specification, a range of “X to Y” can include all integers between X and Y. In addition, for example, the range of “1 to 10” can include, in addition to 1 and 10, all numbers, namely, integers and decimal numbers, between 1 and 10.

Unless defined otherwise, terms used herein (including technical or scientific terms) can have a same meaning as generally understood by those skilled in the art to which the present disclosure pertains. In addition, terms identical to those defined in generally used dictionaries can be interpreted as having meanings identical to contextual meanings of the related art.

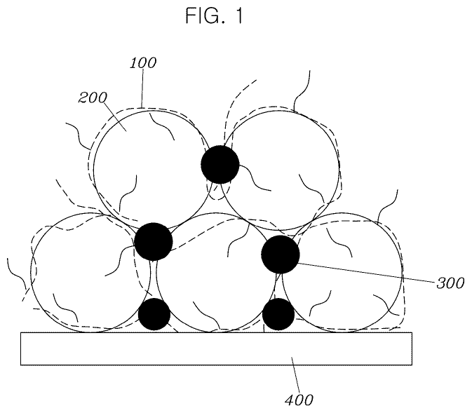

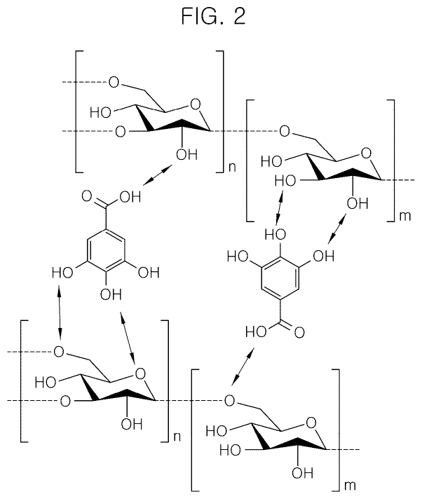

FIG. 1 is a diagram that illustrates a binder for lithium secondary batteries according to an embodiment of the present disclosure. FIG. 2 is a diagram that illustrates a mixture of dextran and gallic acid contained in the lithium secondary battery according to an embodiment of the present disclosure. The binder for lithium secondary batteries according to an embodiment of the present disclosure will be described with reference to FIGS. 1 and 2.

The binder for lithium secondary batteries according to an embodiment of the present disclosure contains a mixture of dextran and gallic acid obtained through physical stirring and the mixture of dextran and gallic acid is shown in FIG. 2, for example.

As shown in FIG. 1, the lithium secondary battery binder 100 of the present disclosure can effectively bind an active material 200 and a conductive material 300 to an electrode substrate 400.

Dextran and gallic acid may be bound through a chemical bond including a hydrogen bond or a covalent bond based on a condensation reaction of dextran and gallic acid.

The binder can be strongly adhered to the surface of the active material by forming a multidimensional contact between the active material and the binder through chemical bonds including polar bonds such as hydrogen bonds and non-polar bonds such as dispersion force.

The weight of gallic acid may be 4 to 6 wt %, based on 100 wt % of the total weight of the mixture of dextran and gallic acid.

The adhesive strength of the lithium secondary battery electrode containing the binder for lithium secondary batteries according to an embodiment of the present disclosure was 20 gf/mm or more upon 180° peel-off test.

Dextran exhibits excellent mechanical strength and has a structure having both a hydrophobic carbon ring and a hydrophilic hydroxyl group, thus exhibiting superior adhesive properties not only to a conductive material containing graphite/carbon of the hydrophobic surface, but also to a silicon-based anode active material of the hydrophilic surface.

Dextran is rigid, but cannot perfectly respond to great volume changes and internal stress of the silicon-based anode active material because it lacks flexibility and has a single polymer chain.

In an attempt to solve this problem, a binder for lithium secondary batteries containing a mixture of dextran and gallic acid chemically bonded to each other may be considered according to an embodiment of the present disclosure.

Gallic acid has three hydroxyl groups, one carboxyl group, and a hydrophobic hexagonal ring.

The abundant polar hydroxyl and carboxyl groups of gallic acid enable hydrogen bonds with an anode active material containing silicon, dextran, and another gallic acid. Such characteristic can impart self-healing capacity to the binder for lithium secondary batteries according to an embodiment of the present disclosure.

The hydrophobic hexagonal ring of gallic acid enables hydrophobic interactions between gallic acid and the active material (graphite), hydrophobic interactions between gallic acids, and reversible non-covalent interactions of galloyl moieties such as gallic acid.

Although an initial bond can be broken due to changes in the volume of the active material during charge/discharge cycling, new bonds between binders and binders, and new bonds between binders and active materials can be formed. This can enable formation of a stable electrode that can avoid pulverization and improves charging capacity according to an embodiment of the present disclosure.

Gallic acid is very rich in hydroxyl groups and thus can form hydrogen bonds with dextran more easily than other single molecules with one or two hydroxyl groups. Based on the interaction between molecules, dextran and gallic acid can be bound effectively according to an embodiment of the present disclosure.

This characteristic can enable chemical bonding between dextran and gallic acid even at a relatively low temperature of about 40° C.

During the process of casting and drying the electrode, a condensation reaction can occur between gallic acid and dextran to form a covalent bond, which can further strengthen the binding between dextran and gallic acid.

The binder for lithium secondary batteries of the present disclosure having these characteristics may be prepared by adding a small amount of gallic acid to dextran without any additional process. This has excellent effects in terms of productivity and cost according to an embodiment of the present disclosure.

The binder for lithium secondary batteries containing a mixture of dextran and gallic acid according to an embodiment of the present disclosure enables multidimensional contact between the active material and the binder through chemical bonds including polar bonds such as hydrogen bonds and nonpolar bonds such as dispersion forces between the anode active material and the binder, and thereby can be strongly adhered to the surface of the active material.

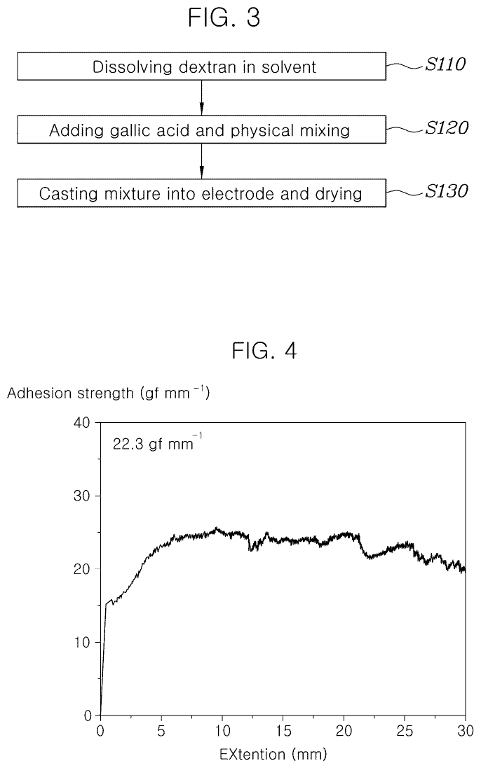

FIG. 3 is a flowchart that illustrates an example of a method of preparing a binder for lithium secondary batteries according to an embodiment of the present disclosure. The method of preparing the binder for lithium secondary batteries according to an embodiment of the present disclosure will be described with reference to FIG. 3.

A method according to an embodiment of the present disclosure may include dissolving dextran in a solvent (operation S110).

The dextran can be dissolved in the solvent in an amount of 5 wt %, based on the total weight of 100 wt % of the mixed solution of solvent and dextran.

The solvent may be a polar solvent including water, for example.

Because water, which is a solvent easily available in the industry, can be used, there are advantages of easy preparation of the process and low cost according to an embodiment of the present disclosure.

The method may include adding gallic acid to the dextran solution, followed by physical mixing (operation S120).

The mixing may be carried out by physical mixing including stirring.

The physical mixing can enable formation of a chemical bond including a hydrogen bond between dextran and gallic acid.

Dextran and gallic acid may be mixed such that the weight of gallic acid is adjusted to 4 to 6 wt % based on the total weight of 100 wt % of the mixture of dextran and gallic acid.

As can be seen from the examples described later, the weight of gallic acid can be within the range defined above in that the silicon anode containing a binder for lithium secondary batteries containing 4 to 6 wt % of gallic acid based on a total weight of 100 wt % of dextran and gallic acid, which exhibited the best battery performance (specific capacity, cycle performance) according to some experiments.

Dextran and gallic acid may be physically mixed by stirring after adding gallic acid to the dextran solution.

The temperature of the dextran solution during stirring may be 30 to 80° C., preferably 30 to 50° C., for example.

The stirring time may be 10 to 14 hours, preferably 11 to 13 hours, for example.

After mixing dextran and gallic acid, the method may further include casting the mixture into an electrode, followed by drying (operation S130).

The drying can enable a covalent bond to be formed between dextran and gallic acid through polymerization to further strengthen the binding between the dextran and gallic acid contained in the mixture.

Hereinafter, the excellent effects of embodiments of the present disclosure will be described and illustrated through comparison between Comparative Examples and Examples of the binders for lithium secondary batteries containing a mixture of dextran and gallic acid according to some embodiments of the present disclosure.

In the method of preparing a mixture of dextran and gallic acid according to an embodiment of the present disclosure, a mixture of dextran and gallic acid was prepared under various conditions of the method and each mixture of dextran and gallic acid was used as a binder to form a silicon-based anode.

Based on these Examples and Comparative Examples, a peel-off test was conducted on silicon-based anodes manufactured using the mixture of dextran and gallic acid, half-cells were manufactured using the manufactured silicon-based anodes, and electrochemical performance thereof was measured.

### [Binder Material Preparation]

### Example 1

5 wt % of dextran was dissolved in water based on a total of 100 wt % of the mixed solution.

Gallic acid was added to the dextran solution in an amount of 6 wt % based on 100 wt % of the total weight of dextran and gallic acid.

Then, gallic acid was added to the dextran solution at 40° C. and stirred for 12 hours to prepare a mixture of dextran and gallic acid.

### Example 2

A mixture of dextran and gallic acid was prepared in the same manner as in Example 1, except that gallic acid was added to the dextran solution in an amount of 5 wt % based on 100 wt % of the total weight of dextran and gallic acid.

### Example 3

A mixture of dextran and gallic acid was prepared in the same manner as in Example 1, except that gallic acid was added to the dextran solution in an amount of 4 wt % based on 100 wt % of the total weight of dextran and gallic acid.

### Comparative Example 1

A mixture of dextran and gallic acid was prepared in the same manner as in Example 1, except that gallic acid was added to the dextran solution in an amount of 10 wt % based on 100 wt % of the total weight of dextran and gallic acid.

### Comparative Example 2

A mixture of dextran and gallic acid was prepared in the same manner as in Example 1, except that gallic acid was added to the dextran solution in an amount of 6.5 wt % based on 100 wt % of the total weight of dextran and gallic acid.

### Comparative Example 3

A mixture of dextran and gallic acid was prepared in the same manner as in Example 1, except that gallic acid was added to the dextran solution in an amount of 3.5 wt % based on 100 wt % of the total weight of dextran and gallic acid.

### Comparative Example 4

A mixture of dextran and gallic acid was prepared in the same manner as in Example 1, except that gallic acid was added to the dextran solution in an amount of 2.5 wt % based on 100 wt % of the total weight of dextran and gallic acid.

### [Electrode Manufacturing]

### Example 4

The solution obtained in Example 1 was used as a binder. A silicon-carbon composite active material, a conductive material, and a binder were mixed to prepare a slurry and the slurry was cast on a current collector to manufacture an electrode. The binder synthesized according to the present disclosure and styrene butadiene rubber (SBR) were used at a weight ratio of 1:1. The electrode was dried at room temperature for one day, pressed and secondarily dried under vacuum at a high temperature (120° C.).

### Example 5

An electrode was manufactured in the same manner as in Example 4, except that the solution obtained in Example 2 was used as a binder.

### Example 6

An electrode was manufactured in the same manner as in Example 4, except that the solution obtained in Example 3 was used as a binder.

### Comparative Example 5

A mixture of dextran and gallic acid was prepared in the same manner as in Example 4, except that the solution obtained in Comparative Example 1 was used as a binder.

### Comparative Example 6

A mixture of dextran and gallic acid was prepared in the same manner as in Example 4, except that the solution obtained in Comparative Example 2 was used as a binder.

### Comparative Example 7

A mixture of dextran and gallic acid was prepared in the same manner as in Example 4, except that the solution obtained in Comparative Example 3 was used as a binder.

### Comparative Example 8

A mixture of dextran and gallic acid was prepared in the same manner as in Example 4, except that the solution obtained in Comparative Example 4 was used as a binder.

### Comparative Example 9

A mixture of dextran and gallic acid was prepared in the same manner as in Example 4, except that a polyacrylic acid solution was used as a binder.

### Comparative Example 10

A mixture of dextran and gallic acid was prepared in the same manner as in Example 4, except that a dextran solution was used as a binder.

### [Adhesive Strength Test]

### Example 7

The adhesive strength of the electrode manufactured in Example 4 was tested (180° peel-off test).

### Example 8

The adhesive strength of the electrode manufactured in Example 5 was tested (180° peel-off test).

### Example 9

The adhesive strength of the electrode manufactured in Example 6 was tested (180° peel-off test).

### Comparative Example 11

The adhesive strength of the electrode manufactured in Comparative Example 5 was tested (180° peel-off test).

### Comparative Example 12

The adhesive strength of the electrode manufactured in Comparative Example 6 was tested (180° peel-off test).

### Comparative Example 13

The adhesive strength of the electrode manufactured in Comparative Example 7 was tested (180° peel-off test).

### Comparative Example 14

The adhesive strength of the electrode manufactured in Comparative Example 8 was tested (180° peel-off test).

### Comparative Example 15

The adhesive strength of the electrode manufactured in Comparative Example 9 was tested (180° peel-off test).

### Comparative Example 16

The adhesive strength of the electrode manufactured in Comparative Example 10 was tested (180° peel-off test).

TABLE 1

| Binder | Adhesive strength (gf/mm) |
|---|---|
| Example 7 | 22.3 |
| Example 8 | 27.2 |
| Example 9 | 22.3 |
| Comparative Example 11 | 12.1 |
| Comparative Example 12 | 16.9 |
| Comparative Example 13 | 18.7 |
| Comparative Example 14 | 14.0 |
| Comparative Example 15 | 4.9 |
| Comparative Example 16 | 8.9 |

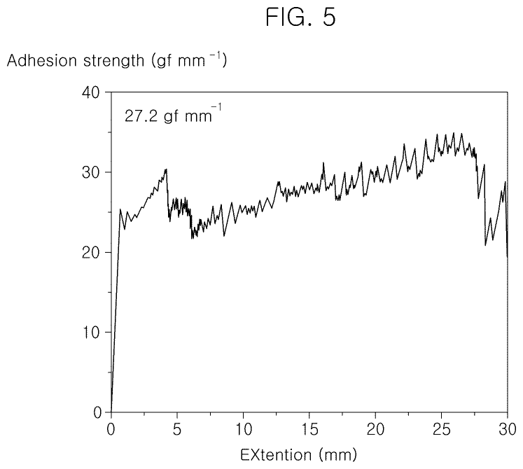

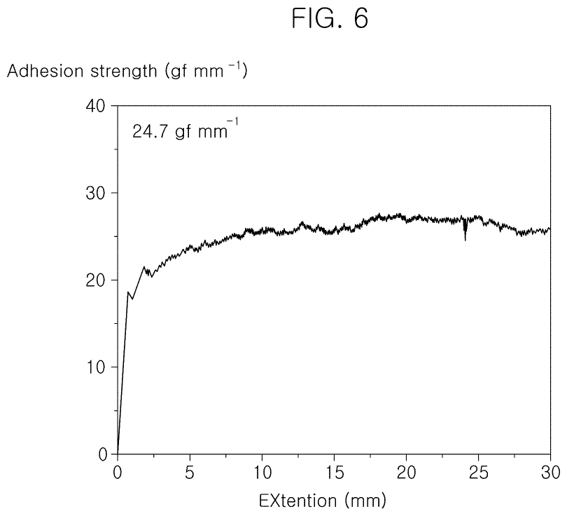

FIGS. 4 to 8 are graphs showing the results of adhesive strength test (180° peel-off test) of electrodes containing the binder for lithium secondary batteries according to some embodiments of the present disclosure.

As can be seen from FIGS. 4 to 6 and Table 1, when the weight of gallic acid is 6 wt %, based on the total weight of 100 wt % of the mixture of dextran and gallic acid, the adhesive strength of the electrode is 22.3 gf/mm and, when the weight of gallic acid is 5 wt % based on the total weight of 100 wt % of the mixture of dextran and gallic acid, the adhesive strength of the electrode is 27.2 gf/mm, and when the weight of gallic acid is 4 wt % based on the total weight of 100 wt % of the mixture of dextran and gallic acid, the adhesive strength of the electrode is 22.3 gf/mm.

This indicates that, when the weight of gallic acid is 4 to 6 wt % based on the total weight of 100 wt % of the mixture of dextran and gallic acid, the electrode has excellent adhesive strength of 20.0 gf/mm or more.

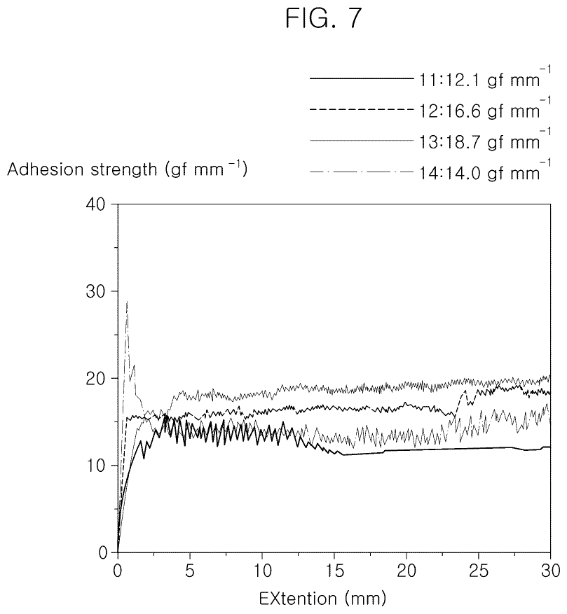

As can be seen from FIG. 7 and Table 1, when the weight of gallic acid is 10 wt %, based on the total weight of 100 wt % of the mixture of dextran and gallic acid, the adhesive strength of the electrode is 12.1 gf/mm and, when the weight of gallic acid is 6.5 wt %, based on the total weight of 100 wt % of the mixture of dextran and gallic acid, the adhesive strength of the electrode is 16.9 gf/mm, when the weight of gallic acid is 3.5 wt %, based on the total weight of 100 wt % of the mixture of dextran and gallic acid, the adhesive strength of the electrode is 18.7 gf/mm, when the weight of gallic acid is 2.5 wt %, based on the total weight of 100 wt % of the mixture of dextran and gallic acid, the adhesive strength of the electrode is 14.0 gf/mm, and when the weight of gallic acid is 2.5 wt %, based on the total weight of 100 wt % of the mixture of dextran and gallic acid, the adhesive strength of the electrode is 14 gf/mm. Within the range of the weight of gallic acid defined above, the electrode has a low adhesive strength of 20 gf/mm or less.

This indicates that, when the weight of gallic acid is out of the range of 4 to 6 wt % based on the total weight of 100 wt % of the mixture of dextran and gallic acid, the electrode has reduced adhesive strength.

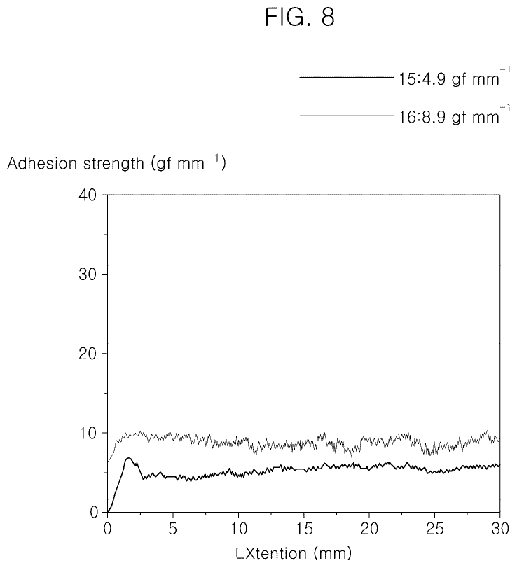

As can be seen from FIG. 8 and Table 1, the adhesive strength of the electrode manufactured using a polyacrylic acid binder instead of the mixture of dextran and gallic acid is 4.9 gf/mm, whereas the adhesive strength of the electrode manufactured using a dextran binder containing no gallic acid is 8.9 gf/mm.

This is because the dextran binder containing no gallic acid has low adhesive strength to the silicon-based anode active material, compared to the binder containing a mixture of dextran and gallic acid.

### [Half-Cell Manufacturing]

### Example 10

A half-cell was manufactured in the form of a coin cell using the electrode manufactured in Example 4 as a working electrode and a lithium metal disk as a counter electrode and a reference electrode. Polypropylene (PP) was used as a separator and a liquid electrolyte was used.

Long-term cycling performance during charge/discharge cycling of electrodes having a mass loading level controlled at 7 mg/cm² was measured in an initial formation cycle (3 cycles) within a voltage range of 0.005 to 1.5V (1 cycle: 0.05 C discharge, 0.02 C constant voltage, 0.1 C charge. 2 cycles; 0.1 C discharge, 0.02 C constant voltage, 0.1 C charge). In the subsequent cycle, charge/discharge was performed at a current density of 0.2 C (discharge), 0.02 C (constant voltage), and 0.5 C (charge).

### Example 11

The long-term cycling performance was measured in the same manner as in Example 10, except that the electrode manufactured in Example 6 was used as the working electrode.

### Example 12

The long-term cycling performance was measured in the same manner as in Example 10, except that the electrode manufactured in Example 7 was used as the working electrode.

### Comparative Example 17

The long-term cycling performance was measured in the same manner as in Example 10, except that the electrode manufactured in Comparative Example 5 was used as the working electrode.

### Comparative Example 18

The long-term cycling performance was measured in the same manner as in Example 10, except that the electrode manufactured in Comparative Example 6 was used as the working electrode.

### Comparative Example 19

The long-term cycling performance was measured in the same manner as in Example 10, except that the electrode manufactured in Comparative Example 7 was used as the working electrode.

### Comparative Example 20

The long-term cycling performance was measured in the same manner as in Example 10, except that the electrode manufactured in Comparative Example 8 was used as the working electrode.

### Comparative Example 21

The long-term cycling performance was measured in the same manner as in Example 10, except that the electrode manufactured in Comparative Example 9 was used as the working electrode.

### Comparative Example 22

The long-term cycling performance was measured in the same manner as in Example 10, except that the electrode manufactured in Comparative Example 10 was used as the working electrode.

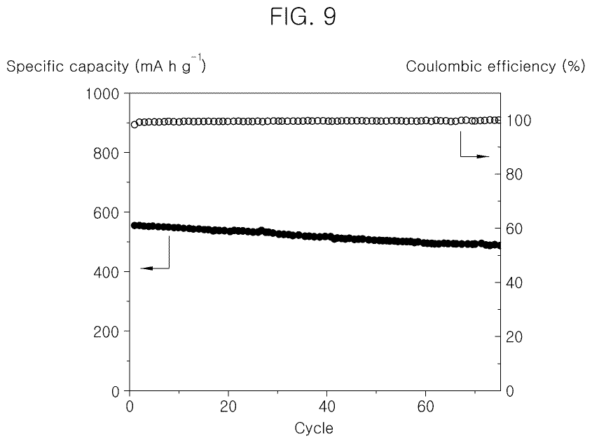

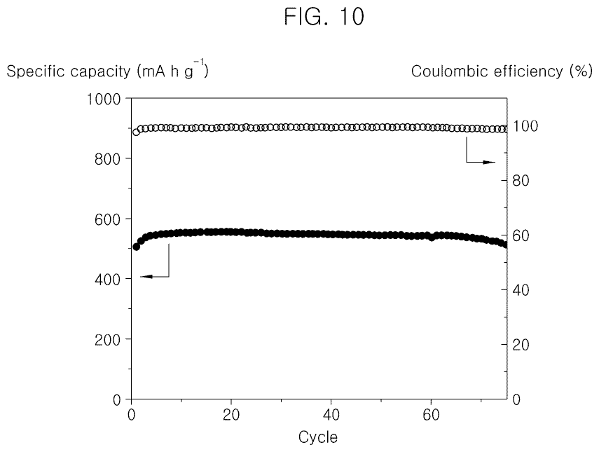

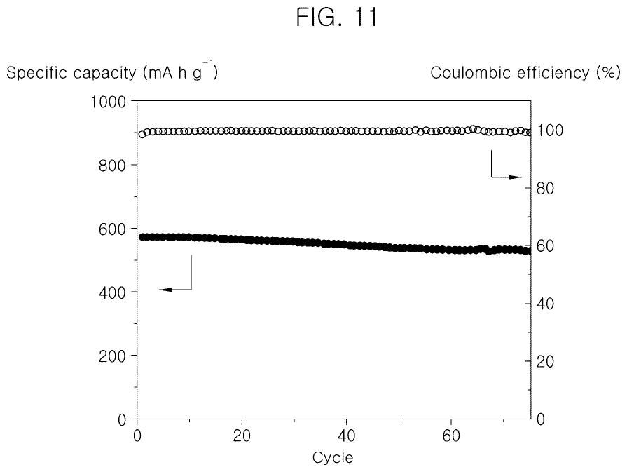

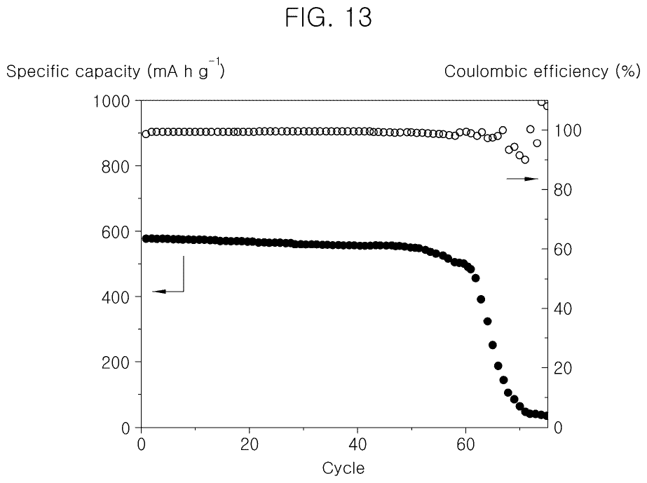

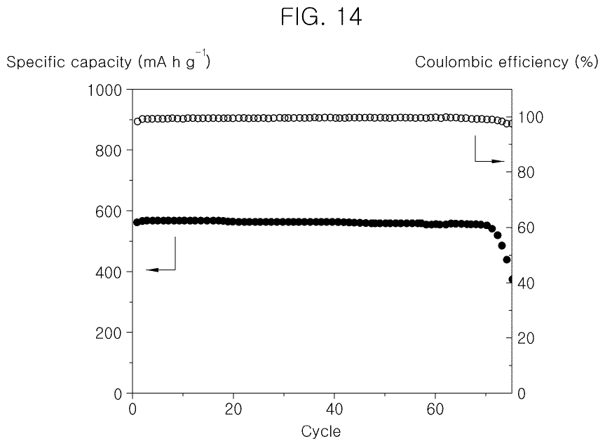

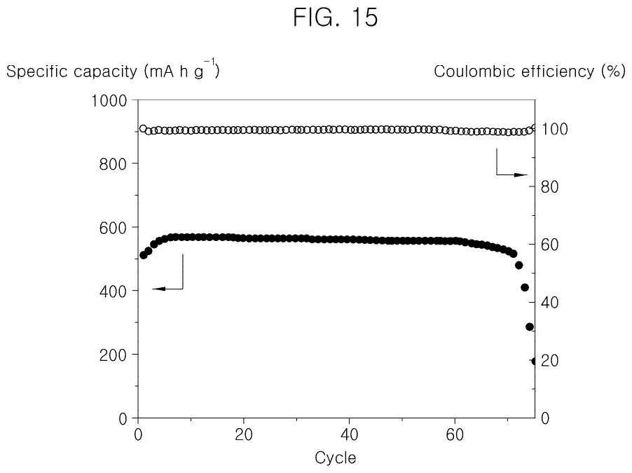

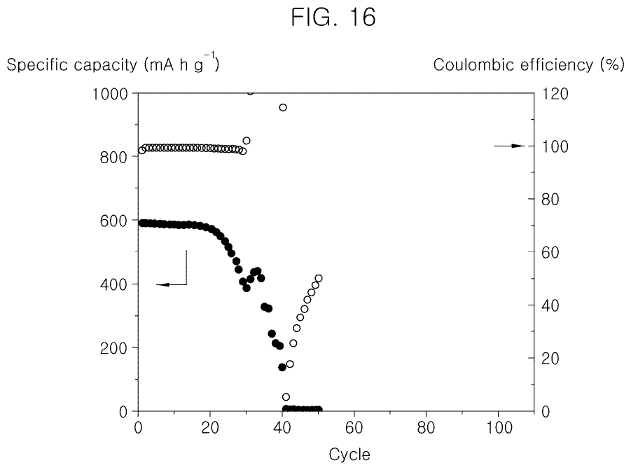

FIGS. 9 to 17 are graphs showing the results of electrochemical lifespan test of half-cells containing the binder for lithium secondary batteries according to some embodiments of the present disclosure.

As can be seen from FIGS. 9 to 11, when the weight of gallic acid falls within the range of 4 to 6 wt %, based on 100 wt % of the total weight of the mixture of dextran and gallic acid, charge-discharge efficiency was effectively maintained even after 60 or more charge-discharge cycles, which indicates excellent electrochemical lifespan.

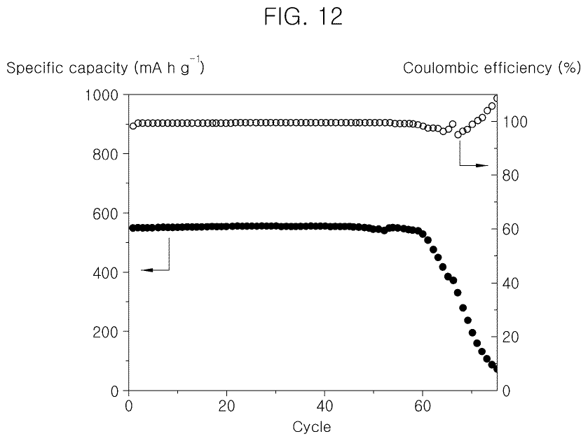

As can be seen from FIGS. 12 to 15, when the weight of gallic acid does not fall within the range of 4 to 6 wt %, based on 100 wt % of the total weight of the mixture of dextran and gallic acid, charge/discharge efficiency rapidly decreased after 40 to 60 or more charge/discharge cycles.

This is because, when gallic acid is contained in excessive amounts, the polymer chains are excessively densely bound and may be broken when the volume of the active material changes during charging and discharging, and the excessive gallic acid may cause side reactions with other parts of the battery.

In addition, when gallic acid is contained in a small amount, the binding of dextran to gallic acid is insufficient, thus making it difficult to insufficiently control the volume change of the active material during charging and discharging. However, it can be seen that this case exhibits better effects compared to a case using dextran alone in FIG. 16.

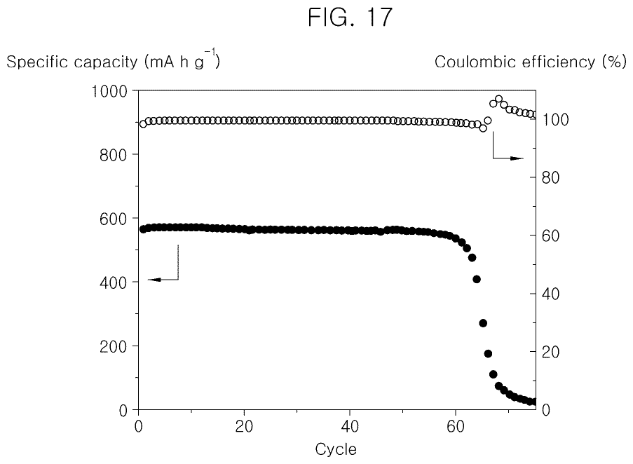

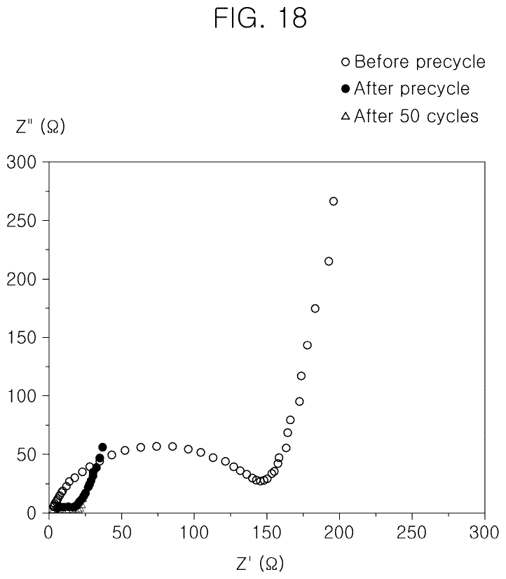

As can be seen from FIGS. 16 and 17, the half-cell manufactured using polyacrylic acid rapidly decreased charge/discharge efficiency after 20 or more charge/discharge cycles.

It can be seen that the half-cell manufactured using dextran alone rapidly decreased charge/discharge efficiency after 60 or more charge/discharge cycles.

The reason for this is that, when polyacrylic acid is used, compatibility between the hydrophilic polyacrylic acid and the hydrophobic silicon-based anode active material and conductive material is low. In addition, polyacrylic acid is a linear polymer and has poor contact strength with the active material when stress is applied, which may be insufficient to effectively control the volume expansion of the silicon-based anode material.

The reason for this is that, when dextran is used alone, it may be difficult or impossible to sufficiently control the volume change of the active material during charging and discharging due to absence of binding of dextran to gallic acid.

### [Electrical Impedance Performance Test]

### Example 13

The resistance of the half-cell obtained in Example 10 before precycle, after precycle, and after 50 cycles was measured using electrochemical impedance spectroscopy (EIS). EIS was performed under the same charging/discharging conditions and frequency range.

### Example 14

Measurement was performed in the same manner as in Example 13, except that the half-cell manufactured in Example 11 was used.

### Example 15

Measurement was performed in the same manner as in Example 13, except that the half-cell manufactured in Example 12 was used.

### Comparative Example 23

Measurement was performed in the same manner as in Example 13, except that the half-cell manufactured in Comparative Example 17 was used.

### Comparative Example 24

Measurement was performed in the same manner as in Example 13, except that the half-cell manufactured in Comparative Example 20 was used.

### Comparative Example 25

Measurement was performed in the same manner as in Example 13, except that the half-cell manufactured in Comparative Example 21 was used.

### Comparative Example 26

Measurement was performed in the same manner as in Example 13, except that the half-cell manufactured in Comparative Example 22 was used.

TABLE 2

| | R_{SEI} + R_{ct} (Ω) | | |
|---|---|---|---|
| Binder | Before precycle | After precycle | After 50 cycles |
| Example 13 | 156 | 17 | 22 |
| Example 14 | 147 | 16 | 26 |
| Example 15 | 169 | 26 | 24 |

R_{SEI} + R_{ct} means the resistance of the half-cell.

TABLE 3

| | R_{SEI} + R_{ct} (Ω) | | |
|---|---|---|---|
| Binder | Before precycle | After precycle | After 50 cycles |
| Comparative | 194 | 21 | 553 |
| Example 23 | | | |
| Comparative | 126 | 22 | 63 |
| Example 24 | | | |
| Comparative | 183 | 14 | — |
| Example 25 | | | |
| Comparative | 136 | 28 | 50 |
| Example 26 | | | |

R_{SEI} + R_{ct} means the resistance of the half-cell.

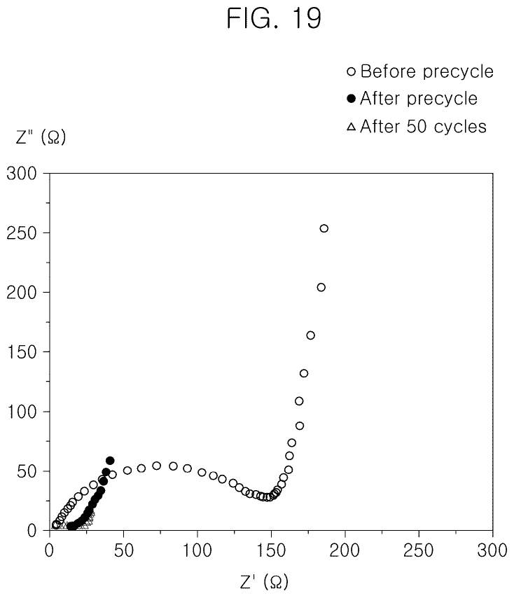

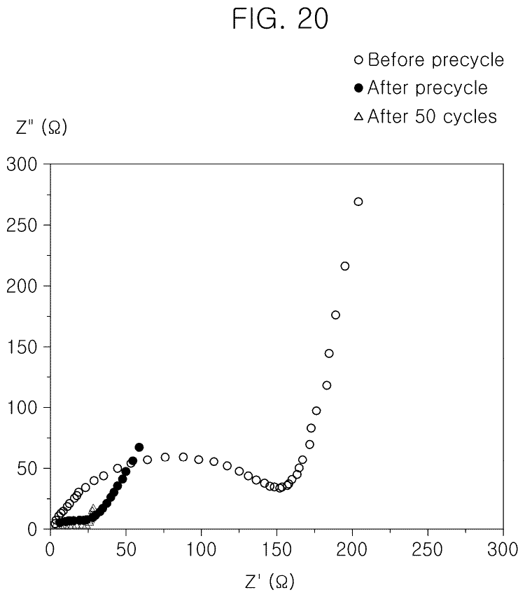

FIGS. 18 to 24 are graphs showing the result of electrochemical life test of the half-cell containing the binder for lithium secondary batteries according to some embodiments of the present disclosure. Tables 2 and 3 show the resistance of the half-cell before charge/discharge precycle, after charge/discharge precycle, and after 50 charge/discharge cycles.

As can be seen from FIGS. 18 to 20 and Table 1, in Example 13 in which the weight of gallic acid is 6 wt % based on the total weight of 100 wt % of the mixture of dextran and gallic acid, the resistance (R_{SEI}+R_{ct}) of the half-cell before precycle was as low as 17Ω, and the resistance (R_{SEI}+R_{ct}) of the half-cell even after 50 or more charge/discharge cycles was also stably maintained at a low level of 22Ω.

In Example 14, in which the weight of gallic acid was 5 wt %, the resistance (R_{SEI}+R_{ct}) of the half-cell before precycle was as low as 16Ω, and the resistance (R_{SEI}+R_{ct}) of the half-cell even after 50 or more charge/discharge cycles was also stably maintained at a low level of 26.2.

In Example 15, in which the weight of gallic acid was 4 wt %, the resistance (R_{SEI}+R_{ct}) of the half-cell before precycle was as low as 26Ω, and the resistance (R_{SEI}+R_{ct}) of the half-cell even after 50 or more charge/discharge cycles was also stably maintained at a low level of 242.

This indicates that, when the weight of gallic acid is 4 to 6 wt %, based on 100 wt % of the total weight of the mixture of dextran and gallic acid, the resistance of the half-cell (R_{SEI}+R_{ct}) was stably maintained at a low level of 30 (or less both after precycle and after 50 or more charge/discharge cycles.

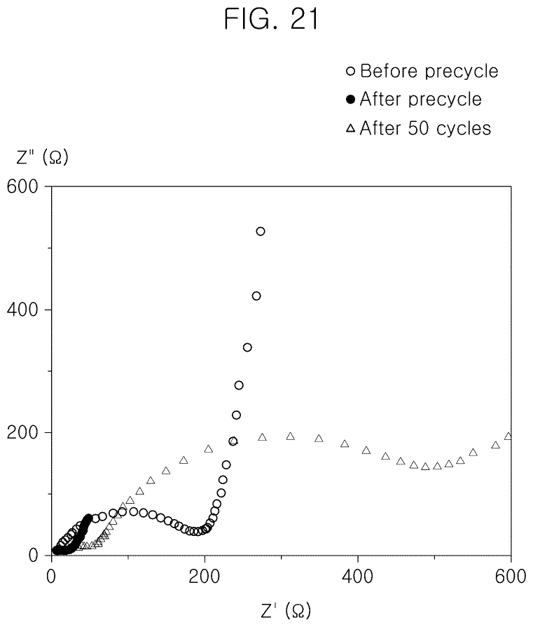

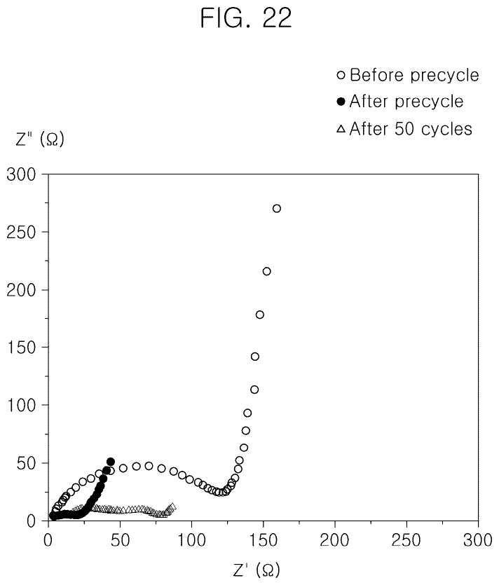

On the other hand, as can be seen from FIGS. 21 and 22 and Table 2, in Comparative Example 23, in which the weight of gallic acid was 2.5 wt %, based on the total weight of 100 wt % of the mixture of dextran and gallic acid, the resistance before precycle was as low as 21Ω, but was increased rapidly to 553 Ω after 50 or more charge/discharge cycles.

In addition, in Comparative Example 24, in which the weight of gallic acid was 10 wt %, the resistance before precycle was as low as 21Ω, but was significantly increased to 63Ω after 50 or more charge/discharge cycles.

This may be due to structural collapse of the silicon-based anode active material resulting from the inability to effectively control the volume change of the silicon-based anode active material during repeated charging and discharging and thus formation of a thick SEI layer.

This indicates that, when the weight of gallic acid was outside the range of 4 to 6 wt %, the resistance (R_{SEI}+R_{ct}) of the half-cell increased to a high level after 50 charge/discharge cycles.

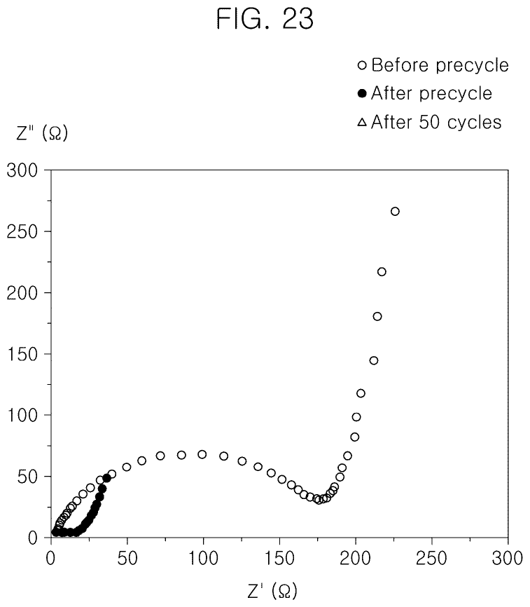

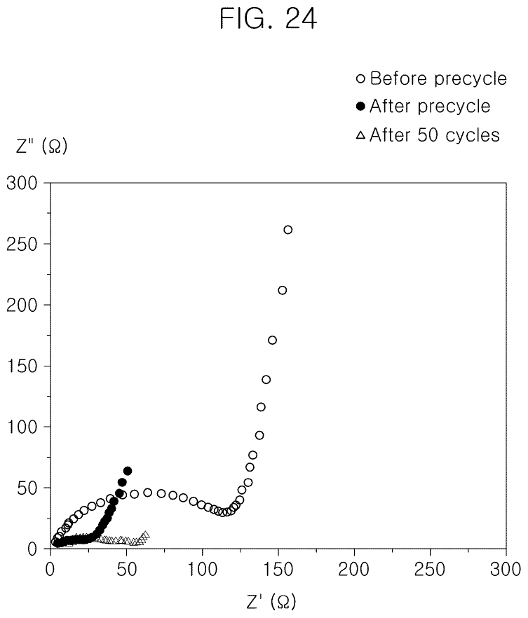

As can be seen from FIGS. 23 and 24 and Table 3, in Comparative Example 24 in which polyacrylic acid is used, the resistance was as low as 14Ω after precycle, but after 40 or more charge/discharge cycles, the electrode was detached and the resistance of the half-cell (R_{SEI}+R_{ct}) was negligible.

In addition, in Comparative Example 25, in which dextran was used alone, the resistance was as low as 280 after the precycle, but was significantly increased to 50Ω after 50 or more charge/discharge cycles.

This indicates that, compared to polyacrylic acid or dextran alone, the mixture of the dextran and gallic acid according to some embodiments of the present disclosure is capable of more effectively maintaining a low half-cell resistance (R_{SEI}+R_{ct}).

As such, when the binder for lithium secondary batteries containing a mixture of dextran and gallic acid according to some embodiments of the present disclosure is used as a binder for the silicon anode of lithium ion batteries that undergo extreme volume changes during intercalation/deintercalation of lithium ions in lithium secondary batteries, it can reduce the volume change of the silicon-carbon composite-based anode active material and exhibit excellent electrochemical performance.

As is apparent from the above description, some embodiments of the present disclosure provide a binder for lithium secondary batteries containing a mixture of dextran and gallic acid. Some embodiments of the present disclosure provide a binder for an anode of lithium secondary batteries that can effectively reduce large volume changes during charging and discharging of anode active materials, especially silicon-based anode active materials, and improve the mechanical stability, rate characteristics, and charge/discharge cycling stability of the anode, thereby improving the charge/discharge performance and lifespan characteristics of batteries using the same.

In addition, the binder is advantageously highly reproducible and can be prepared through simple mixing according to some embodiments of the present disclosure.

The advantages that can be obtained from some embodiments of the present disclosure the present disclosure are not necessarily limited to those mentioned above and other advantages can be clearly understood by those skilled in the art from the description above.

Although the some embodiments of the present disclosure have been disclosed for illustrative purposes, those skilled in the art will appreciate that various modifications, additions, and substitutions can be possible, without departing from the scope and spirit of the present disclosure according to the accompanying claims.

What is claimed is:

1. A binder for a lithium secondary battery comprising a mixture of dextran and gallic acid obtained through physical stirring.

2. The binder of claim 1, wherein the dextran and the gallic acid form a chemical bond through the physical stirring.

3. The binder of claim 2, wherein the chemical bond between the dextran and the gallic acid comprises a hydrogen bond.

4. The binder of claim 2, wherein the chemical bond between the dextran and the gallic acid comprises a covalent bond through polymerization.

5. The binder of claim 1, wherein a weight of the gallic acid is 4 to 6 wt %, based on 100 wt % of a total weight of the mixture of the dextran and the gallic acid.

6. The binder of claim 1, wherein the binder is prepared by adding the gallic acid to a dextran solution, followed by the physical stirring.

7. The binder of claim 1, wherein the mixture of the dextran and the gallic acid forms a multidimensional contact with an anode active material.

8. A method of preparing a binder for a lithium secondary battery comprising:
dissolving dextran in a solvent to form a dextran solution;
adding gallic acid to the dextran solution; and
after the adding of the gallic acid to the dextran solution, physically mixing the dextran solution including the added gallic acid to form a mixture.

9. The method of claim 8, wherein the solvent is a polar solvent comprising water.

10. The method of claim 8, wherein the dextran and the gallic acid during the physically mixing are mixed such that a weight of the gallic acid is 4 to 6 wt % based on a total weight of 100 wt % of the mixture.

11. The method of claim 8, wherein the physically mixing is performed by stirring after the adding of the gallic acid to the dextran solution.

12. The method of claim 8, wherein a temperature of the dextran solution during the physically mixing is 30 to 50° C.

13. The method of claim 11, wherein a time of the stirring during the physically mixing is 11 to 13 hours.

14. The method of claim 8, further comprising:
casting the mixture onto an electrode; and
drying the electrode after the casting.

15. An anode for the lithium secondary battery comprising the binder of claim 1.

16. The anode of claim 15, wherein the anode has an adhesive strength, measured by 180° peel-off test, of 20 gf/mm or more.

17. A lithium secondary battery comprising a binder including a mixture of dextran and gallic acid obtained through physical stirring.

18. The lithium secondary battery of claim 17, wherein the lithium secondary battery has a resistance of 3002 or less after 50 repeated charge/discharge cycles.
